(19) United States
(12) Patent Application Publication
(10) Pub. No.: US 2008/0096038 A1
(43) Pub. Date: Apr. 24, 2008

(54) Method for Friction-Stir-Welding Hollow Workpieces

(75) Inventor: Yoshitaka Nagano, Oyama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SHOWA DENKO K.K, Minato-ku, Tokyo (JP)

(21) Appl. No.: 11/572,501

(22) PCT Filed: Jul. 29, 2005
(86) PCT No.: PCT/JP05/14372

§ 371 Date: Jan. 23, 2007

Related U.S. Application Data
(60) Provisional application No. 60/598,061, filed on Aug. 3, 2004.

(30) Foreign Application Priority Data
Jul. 29, 2004 (JP) 2004-221462

(51) Int. Cl. F16L 9/02; B23K 20/12

(52) U.S. Cl. 428/586; 228/112.1

(57) ABSTRACT

A method for friction-stir-welding two hollow workpieces. While open end portions of the workpieces butt each other, and an annular support member supports the butt end portions from the inside, the workpieces are joined together by friction stir welding. An annular, radially outward projection is formed on the entire outer circumferential surface of the support member in an intermediate region along the support member width. Support portions to be fitted into corresponding end portions of the workpieces for support from the inside are formed on the support member at corresponding opposite sides of the annular, radially outward projection. While the support portions are fitted into the workpieces, respectively, and end faces of the workpieces abut the annular, radially outward projection, the butt end portions of the workpieces and the support member are friction stir welded from the outside. Thereby, the hollow workpieces are welded without joint defect.

### CROSS REFERENCE TO RELATED APPLICATIONS

This application is an application filed under 35 U.S.C. § 111(a) claiming the benefit pursuant to 35 U.S.C. § 119(e)(1) of the filing date of Provisional Application No. 60/598,061 filed Aug. 3, 2004 pursuant to 35 U.S.C. § 111(b).

### TECHNICAL FIELD

The present invention relates to a method for friction-stir-welding hollow workpieces in order to manufacture metal products for use in various industries.

Herein and in the appended claims, the term “aluminum” encompasses aluminum alloys in addition to pure aluminum.

### BACKGROUND ART

In order to join abutting open end portions of hollow workpieces, such as tubes or hollow shapes, arc welding, such as MIG or TIG, has been employed. However, when arc welding is used to join heat-treatment-type alloys, such as JIS A6000 family alloys, heat input during welding has caused an impairment in strength, and occurrence of thermal strain in a heat affected zone.

In recent years, in order to solve such a problem, a friction stir welding process, which is a solid-phase joining process, has been applied.

For example, according to a known method for friction-stir-welding hollow workpieces, while open end portions of two cylindrical members to be joined are directly butted with each other in such a manner that their outer circumferential surfaces are positioned at the same surface, and an annular support member is disposed so as to support the butt end portions from the inside, the two members and the support member are subjected to friction stir welding that is performed from the outside (refer to publication of Japanese Patent No. 3297845).

In the method described in the publication, in order to obtain a sound joint portion between the two members and the support member, before joining is started, the support member must be press-fitted into the butt end portions of the two members to be joined. However, when the support member is press-fitted into the butt end portions of the two workpieces to be joined, difficulty is involved in disposing the support member at a proper position in relation to the two members to be joined, without involvement of any dislocation. Accordingly, the conventional method potentially involves dislocation of the support member in relation to the two members to be joined, thus involving the risk of occurrence of defect in a joint portion.

An object of the present invention is to solve the above problems and to provide a method for friction-stir-welding hollow workpieces without involvement of occurrence of joint defect.

### DISCLOSURE OF THE INVENTION

To achieve the above object, the present invention comprises the following modes.

1) A method for friction-stir-welding hollow workpieces wherein, while open end portions of two hollow workpieces to be joined are butted with each other in such a manner that their outer perimeter surfaces are positioned at the same surface, and an annular support member is disposed so as to support the butt end portions from the inside, the workpieces are joined together by friction stir welding that is performed from the outside. The method is characterized in that an annular, radially outward projection is formed on the entire outer perimeter surface of the support member in an intermediate region in the axial direction of the support member, and support portions to be fitted into the corresponding butt end portions of the workpieces for supporting the workpieces from the inside are formed on the support member at corresponding opposite sides of the annular, radially outward projection and that, while the support portions of the support member are fitted into the corresponding workpieces, and end faces of the workpieces abut the annular, radially outward projection, the butt end portions of the workpieces and the support member are subjected to friction stir welding that is performed from the outside.

2) A method for friction-stir-welding hollow workpieces according to par. 1), wherein, when W mm represents the width of the annular, radially outward projection in the axial direction of the support member, and D mm represents the probe diameter of a friction stir welding tool, the condition D−W≧1.5 mm is satisfied.

3) A method for friction-stir-welding hollow workpieces according to par. 1), wherein the butt end portions of the two workpieces to be joined are of the same wall thickness and the same inner perimeter length, and the opposite support portions of the support member are of the same outer perimeter length.

4) A method for friction-stir-welding hollow workpieces according to par. 3), wherein, when H mm represents the height of the annular, radially outward projection as measured from the outer perimeter surface of the support member, and T mm represents the wall thickness of the butt end portions of the two workpieces to be joined, the condition T≦H≦1.2 T is satisfied.

5) A method for friction-stir-welding hollow workpieces according to par. 3), wherein, when Lb mm represents the outer perimeter length of the opposite support portions of the support member, and Lp mm represents the inner perimeter length of the butt end portions of the two workpieces to be joined, the condition Lp≦Lb≦1.01 Lp is satisfied.

6) A method for friction-stir-welding hollow workpieces according to par. 1), wherein the butt end portions of the two workpieces to be joined differ from each other in wall thickness and inner perimeter length; the support member has a first support portion on one side of the annular, radially outward projection so as to support, from the inside, a first workpiece of the two workpieces, the first workpiece having a thin-walled butt end portion; the support member has a second support portion on the other side of the annular, radially outward projection so as to support, from the inside, a second workpiece of the two workpieces, the second workpiece having a thick-walled butt end portion; and the outer perimeter length of the first support portion is longer than the outer perimeter length of the second support portion.

7) A method for friction-stir-welding hollow workpieces according to par. 6), wherein, when H₁ mm represents the height of the annular, radially outward projection of the support member as measured from the outer perimeter surface of the first support portion, T₁ mm represents the wall thickness of the thin-walled butt end portion of the first workpiece to be joined, H₂ mm represents the height of the annular, radially outward projection as measured from the outer perimeter surface of the second support portion, and T₂ mm represents the wall thickness of the thick-walled butt end portion of the second workpiece to be joined, the conditions T₁≦H₁≦1.2 T, and T₂≦H₂≦1.2 T₂ are satisfied.

8) A method for friction-stir-welding hollow workpieces according to par. 6), wherein, when Lb₁ mm represents the outer perimeter length of the first support portion of the support member, Lp₁ mm represents the inner perimeter length of the thin-walled butt end portion of the first workpiece to be joined, Lb₂ mm represents the outer perimeter length of the second support portion of the support member, and Lp₂ mm represents the inner perimeter length of the thick-walled butt end portion of the second workpiece to be joined, the conditions Lp₁≦Lb₁≦1.01 Lp₁ and Lp₂≦Lb₂≦1.01 Lp₂ are satisfied.

9) A method for friction-stir-welding hollow workpieces according to par. 1), wherein end portions of the opposite support portions of the support member are formed into tapered portions such that a perimeter length gradually reduces toward respective distal ends.

10) A method for friction-stir-welding hollow workpieces according to par. 1), wherein the two workpieces to be joined and the support member are formed of aluminum.

11) A method for friction-stir-welding hollow workpieces according to par. 10), wherein the two workpieces to be joined and the support member are formed of a JIS A6000 family alloy.

12) A tubular member formed by joining a plurality of tubular workpieces each opened at opposite ends, wherein adjacent tubular workpieces are friction-stir-welded by a method according to any one of pars. 1) to 11).

13) A vessel comprising a trunk and a closing wall for closing at least one end of the trunk, the trunk being formed by joining a plurality of longitudinal vessel component members such that the adjacent vessel component members are friction-stir-welded by a method according to any one of pars. 1) to 11).

According to the method of par. 1), the annular, radially outward projection is formed on the entire outer perimeter surface of the support member in an intermediate region in the axial direction of the support member; the support portions to be fitted into the corresponding butt end portions of the two workpieces for supporting the workpieces from the inside are formed on the support member at corresponding opposite sides of the annular, radially outward projection; the support portions of the support member are fitted into the corresponding butt end portions of the workpieces; and the end faces of the workpieces abut the annular, radially outward projection. Thus, dislocation of the support member in relation to the workpieces can be readily and reliably prevented. Therefore, the workpieces and the support member can be joined together without occurrence of defect. Further, since dislocation of the support member in relation to the workpieces can be prevented, the required length of the support member can be minimized.

The method of par. 2) can prevent an impairment in joining strength of a joint portion between the two workpieces.

The method of par. 3) can join together two workpieces whose butt end portions are of the same wall thickness and the same inner perimeter length, without occurrence of joint defect.

The method of par. 4) can reduce a reduction in wall thickness of a joint portion, thereby preventing an impairment in joining strength.

With the method of par. 5), when the two workpieces to be joined and the support member are assembled, there can be prevented formation of a gap between the inner perimeter surfaces of the butt end portions of the workpieces and the corresponding outer perimeter surfaces of the opposite support portions of the support member, thereby providing a sound joint portion free from occurrence of defect.

The method of par. 6) can join together two workpieces whose butt end portions differ from each other in wall thickness and inner perimeter length, without occurrence of joint defect.

The method of par. 7) can reduce a reduction in wall thickness of a joint portion, thereby preventing an impairment in joining strength.

With the method of par. 8), when the two workpieces to be joined and the support member are assembled, there can be prevented formation of a gap between the inner perimeter surfaces of the butt end portions of the workpieces and the corresponding outer perimeter surfaces of the opposite support portions of the support member, thereby providing a sound joint portion free from occurrence of defect.

The method of par. 9) allows the opposite support portions of the support member to be fitted into the members to be joined, in relatively easy manner.

As in the case of the method of par. 11), even when the two workpieces to be joined and the support member are formed of a JIS A6000 family alloy, which is a heat-treatment-type alloy, the workpieces and the support member can be prevented from suffering an impairment in strength, and occurrence of thermal strain which could otherwise result from thermal affection.

### BRIEF DESCRIPTION OF THE DRAWINGS

FIG. 1 is an exploded perspective view showing a method according to Embodiment 1 of the present invention. FIG. 2 is a partially enlarged sectional view showing the method according to Embodiment 1 of the present invention and a condition in which opposite support portions of a support member are fitted into two corresponding workpieces to be joined, and end faces of the workpieces abut corresponding side faces of an annular, radially outward projection of the support member. FIG. 3 is a partially enlarged sectional view showing a joint portion between the two workpieces and the support member which are joined together by the method according to Embodiment 1 of the present invention. FIG. 4 is a longitudinal sectional view of a vessel manufactured by the method according to Embodiment 1 of the present invention.

FIG. 5 is a partially enlarged sectional view showing a method according to Embodiment 2 of the present invention and a condition in which opposite support portions of a support member are fitted into two corresponding workpieces to be joined, and end faces of the workpieces abut corresponding side faces of an annular, radially outward projection of the support member. FIG. 6 is a partially enlarged sectional view showing a joint portion between the two workpieces and the support member which are joined together by the method according to Embodiment 2 of the present invention.

### BEST MODE OF CARRYING OUT THE INVENTION

Embodiments of the present invention will be described below with reference to the drawings.

### Embodiment 1

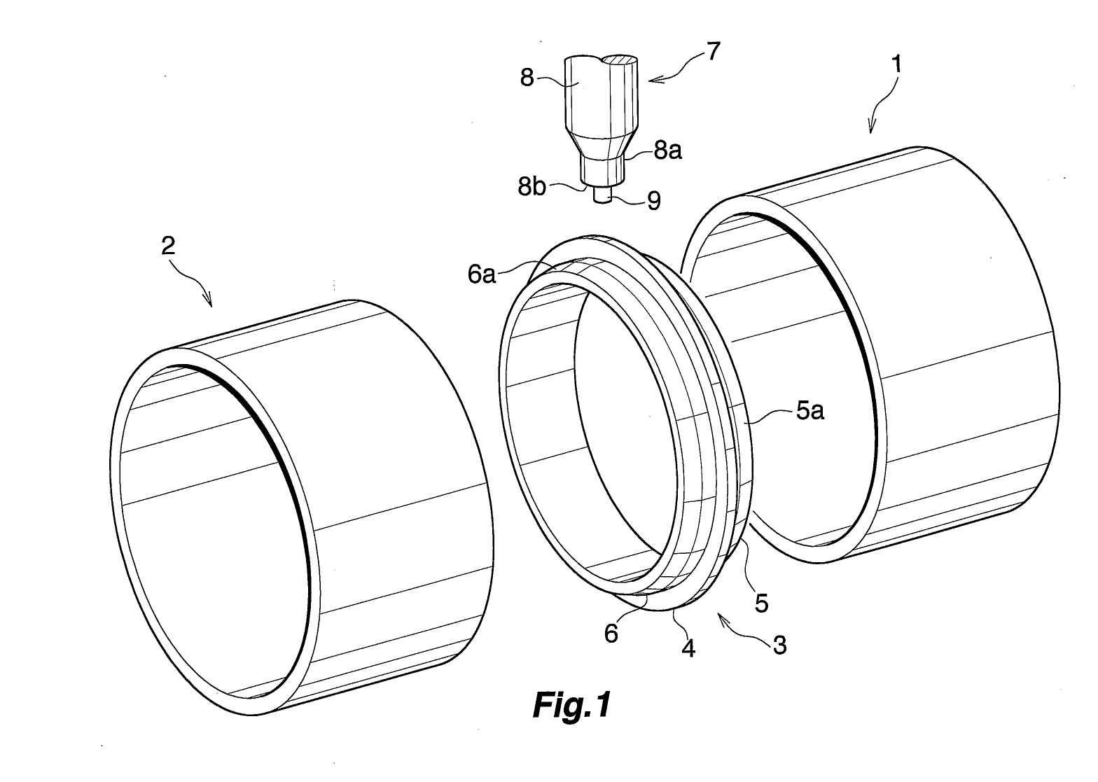

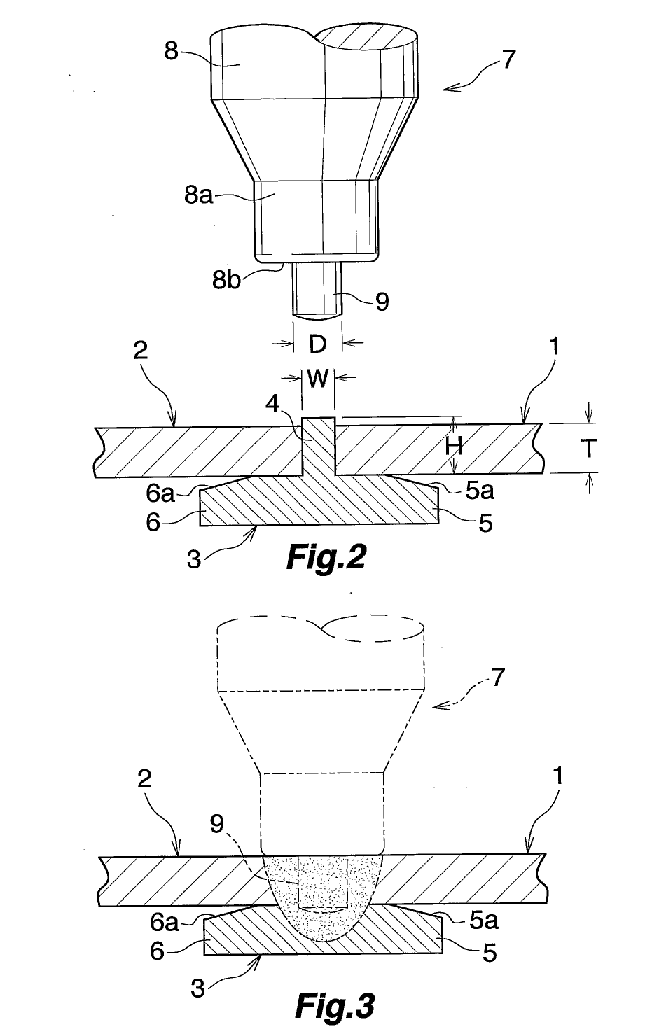

The present embodiment is shown in FIGS. 1 to 3.

First, two cylindrical workpieces (1) and (2), each opened at opposite ends, are prepared as members to be joined. Also, an annular (short, cylindrical) support member (3) is prepared. The workpieces (1) and (2) are of the same wall thickness and the same inside diameter; i.e., the inner circumferential length is constant along the overall axial length, so that butt end portions of the workpieces (1) and (2) are of the same wall thickness and the same inner circumferential length. An annular, radially outward projection (4) is integrally formed on the outer circumferential surface of the support member (3) in an intermediate region in the axial direction of the support member (3). Opposite support portions (5) and (6) to be fitted into corresponding open end portions of the workpieces (1) and (2) for supporting the workpieces (1) and (2) from the inside are formed on the support member (3) at the corresponding opposite sides of the annular, radially outward projection (4). The opposite support portions (5) and (6) of the support member (3) are of the same circumferential length. End portions of the outer circumferential surfaces of the support portions (5) and (6) are reduced in diameter toward the respective distal ends. Thus, the end portions of the support portions (5) and (6) are formed into tapered portions (5a) and (6a), respectively, such that the circumferential length gradually reduces toward the distal end.

Preferably, when H mm represents the height of the annular, radially outward projection (4) as measured from the outer circumferential surfaces of the opposite support portions (5) and (6) of the support member (3), and T mm represents the wall thickness of the two workpieces (1) and (2) to be joined, the condition T≦H≦1.2 is satisfied (see FIG. 2). When T>H, the wall thickness of a joint portion reduces, potentially resulting in an impairment in joining strength. Through employment of T≦H, a reduction in the wall thickness of the joint portion can be reduced; however, even when 1.2 T<H is employed, the effect remains almost unchanged. Accordingly, it is preferred to satisfy the condition T≦H≦1.2 T. Preferably, when Lb mm represents the outer circumferential length of the opposite support portions (5) and (6), excluding the tapered portions (5a) and (6a), of the support member (3), and Lp mm represents the inner circumferential length of the two workpieces to be joined, the condition Lp≦Lb≦1.01 Lp is satisfied. When Lb<Lp, a gap may be formed between the inner circumferential surfaces of the butt end portions of the workpieces and the corresponding outer circumferential surfaces of the opposite support portions, resulting in a failure to provide a sound joint portion. When Lb>1.01 Lp, difficulty may be involved in fitting the support portions (5) and (6) into the workpieces (1) and (2), respectively.

The workpieces (1) and (2) to be joined and the support member (3) are formed of any one of, for example, JIS A2000 family alloys, JIS A5000 family alloys, JIS A6000 family alloys, and JIS A7000 family alloys; for example, a JIS A6000 alloy. The workpieces (1) and (2) and the support member (3) may be formed of the same material or different materials. The workpieces (1) and (2) are formed by an appropriate process, such as extrusion, forging, or machining.

Next, the opposite support portions (5) and (6) of the support member (3) are fitted into the corresponding open end portions of the workpieces (1) and (2) to be joined, and the end faces of the workpieces (1) and (2) are caused to abut the corresponding opposite side faces of the annular, radially outward projection (4). By use of a friction stir welding tool (7), the workpieces (1) and (2) and the support member (3) are friction-stir-welded.

The friction stir welding tool (7) includes a columnar rotor (8) having a small-diameter portion (8a), which is formed at an end portion thereof coaxially and integrally via a taper portion, and a pin-like probe (9), which is formed on the end face of the small-diameter portion (8a) coaxially and integrally with the small-diameter portion (8a) and has a diameter smaller than that of the small-diameter portion (8a). The rotor (8) and the probe (9) are formed of a material harder than a material for the workpieces (1) and (2), and having heat resistance to endure frictional heat that is generated during joining.

Preferably, when W mm represents the width of the annular, radially outward projection (4) in the axial direction of the support member (3), and D mm represents the diameter of the probe (9), the condition D−W≧1.5 mm is satisfied (see FIG. 2). When D−W<1.5 mm, stirring of the material of the workpieces (1) and (2) and the material of the support member (3) becomes insufficient, potentially resulting in an impairment in joining strength of a joint portion therebetween. The upper limit of D−W is, for example, about 10 mm. The length of the probe (9) is preferably equal to or longer than the wall thickness of open end portions of the workpieces (1) and (2).

Next, while the friction stir welding tool (7) is rotated, the probe (9) is plunged into the abutting portions of the workpieces (1) and (2), at one circumferential position, and a shoulder portion (8b) between the small-diameter portion (8a) and the probe (9) in the tool (7) is pressed against the outer circumferential surfaces of the workpieces (1) and (2). At this time, the center of the probe (9) is caused to coincide with the center of the annular, radially outward projection (4) along the width thereof. Since D−W≧1.5 mm, the probe (9) is plunged into the workpieces (1) and (2) including the annular, radially outward projection (4), and the shoulder portion (8b) is pressed against the outer circumferential surfaces of the workpieces (1) and (2). Pressing the shoulder portion (8b) against the workpieces (1) and (2) prevents splashing of plasticized material which could otherwise occur at the beginning of and in the course of joining, whereby a joint portion can be formed in a good condition. Sliding contact between the shoulder portion (8b) and the workpieces (1) and (2) further generates frictional heat to thereby accelerate softening of the material in the contact regions, including their peripheral regions, between the probe (9) and the workpieces (1) and (2) and the material in the contact region, including its peripheral region, between the probe (9) and the support member (3), and prevents occurrence of pits and projections, such as burrs, on the surface of a joint portion.

Through relative movement between the friction stir welding tool (7) and the workpieces (1) and (2), the probe (9) is moved circumferentially in the above-mentioned abutting portions.

Frictional heat generated by rotation of the probe (9) and frictional heat generated by sliding contact between the shoulder portion (8b) and the workpieces (1) and (2) cause the base metal of the workpieces (1) and (2) and that of the support member (3) to soften in a region of the above-mentioned abutting portions and its peripheral region. The. thus-plasticized material is stirred and mixed through subjection to the rotative force of the probe (9) and is transferred in such a manner as to fill a groove that is formed through passage of the probe (9). Subsequently, the plasticized material quickly loses frictional heat to thereby be cooled and solidified. This phenomenon repeatedly occurs as the probe (9) moves, whereby joining between the workpieces (1) and (2) and the support member (3) progresses. At this time, the annular, radially outward projection (4) of the support member (3) is joined to the workpieces (1) and (2) in a completely integral manner, and regions of the opposite support portions (5) and (6) adjacent to the annular, radially outward projection (4) are also joined to the workpieces (1) and (2) (see FIG. 3).

Upon completion of movement of the probe (9) along the entire circumference of the above-mentioned abutting portions, the two workpieces (1) and (2) and the support member (3) are joined together along the entire circumference thereof. Then, the probe (9) is moved to a stopper member (not shown) disposed at a terminal position of the abutting faces of the workpieces (1) and (2) and is removed. The workpieces (1) and (2) and the support member (3) are thus friction-stir-welded.

In above Embodiment 1, the workpieces (1) and (2) are of the same inner circumferential length and the same wall thickness along the overall axial length thereof. However, no limitation is imposed on the dimensions of the workpieces (1) and (2), so long as their open end portions to be butted together are of the same inner circumferential length and the same wall thickness.

Next, specific experiment examples of the method of Embodiment 1, together with a Reference Example, will be described.

### Experiment Examples 1 to 7

Two workpieces (1) and (2) formed of JIS A6061-T6 were prepared. The workpieces (1) and (2) had an outside diameter of 200 mm, an inside diameter of 190 mm, and a wall thickness of 5 mm. Also, the support member (3) formed of JIS A6061-T6 was prepared. The support member (3) was configured as follows: the opposite support portions (5) and (6) excluding the tapered portions (5a) and (6a) has an outside diameter of 190 mm and an inside diameter of 160 mm, and the annular, radially outward projection (4) has an outside diameter of 200 mm and a height H of 5 mm as measured from the outer circumferential surfaces of the support portions (5) and (6). The friction stir welding tool (7) prepared was configured as follows: diameter of shoulder portion (8b) as measured on end face of small-diameter portion (8a) of rotor (8): 15 mm; diameter of probe (9): 5 mm; and length of probe (9): 5 mm.

With the width of the annular, radially outward projection (4) in the axial direction of the support member (3) being varied, the two workpieces (1) and (2) and the support member (3) were friction-stir-welded according to the method of Embodiment 1.

### Reference Example

The two workpieces (1) and (2) and the support member were friction-stir-welded in a manner similar to that of Experiment Examples 1 to 7 except for the following: by use of a support member having no annular, radially outward projection, the end faces of the workpieces (1) and (2) were directly butted with each other, and the support member was disposed such that the position of a central portion of the support member in the length direction thereof coincided with that of the abutting end faces of the workpieces (1) and (2).

Subsequently, test pieces were prepared from joint portions of joined assemblies which were obtained by joining together the two workpieces (1) and (2) and the support member (3) in Experiments 1 to 7 and Reference Example. The test pieces were subjected to a tensile test to measure the tensile strength of the joint portions. Table 1 shows the test results. Tensile strength appearing in Table 1 is represented in relation to that of Reference Example that is taken as 1.0.

TABLE 1

| | Width of Annular, | | |
|---|---|---|---|
| | Radially Outward | D − W | Tensile |
| | Projection: W (mm) | (mm) | Strength |
| Experiment Example 1 | 1.0 | 4.0 | 1.0 |
| Experiment Example 2 | 2.0 | 3.0 | 1.0 |
| Experiment Example 3 | 2.5 | 2.5 | 1.0 |
| Experiment Example 4 | 3.0 | 2.0 | 1.0 |
| Experiment Example 5 | 3.5 | 1.5 | 1.0 |
| Experiment Example 6 | 4.0 | 1.0 | 0.8 |
| Experiment Example 7 | 4.5 | 0.5 | 0.7 |

As is apparent from the test results shown in Table 1, the condition D−W≧1.5 mm is preferred for the relationship between the probe diameter D mm and the width W mm of the annular, radially outward projection (4) in the axial direction of the support member (3).

FIG. 4 shows a vessel that is manufactured by use of the method of Embodiment 1.

In FIG. 4, a vessel (10) includes a cylindrical trunk (11) and a closing wall (12) for closing at least one opening end of the trunk (11). The vessel (10) is composed of a first vessel component member (13), which is opened at opposite ends, extruded aluminum pipe and forms most of the trunk (11), and a second vessel component member (14), which is joined to at least one end portion of the first vessel component member (13) to thereby form a portion of the trunk (11), and the closing wall (12). The second vessel component member (14) is formed through forging or machining.

The first vessel component member (13) has a cylindrical portion (15), which forms most of the trunk (11). The second vessel component member (14) has a short, cylindrical portion (16), which forms a portion of the trunk (11), and a dome-like portion (17), which closes one end of the short, cylindrical portion (16) and forms the closing wall (12).

The wall thickness and the inner circumferential length of the cylindrical portion (15) of the first vessel component member (13) are equal to those of an open end portion of the short, cylindrical portion (16) of the second vessel component member (14). An end portion of the cylindrical portion (15) of the first vessel component member (13) and an end portion of the short, cylindrical portion (16) of the second vessel component member (14) are joined together in the following manner. While the opposite support portions (6) and (5) of the support member (3) are fitted into the open end portion of the cylindrical portion (15) of the first vessel component member (13) and the open end portion of the short, cylindrical portion (16) of the second vessel component member (14), respectively, and the end face of the cylindrical portion (15) and the end face of the short, cylindrical portion (16) abut the corresponding opposite side faces of the annular, radially outward projection (4), the two vessel component members (11) and (12) and the support member (3) are friction-stir-welded by a method similar to that of Embodiment 1.

### Embodiment 2

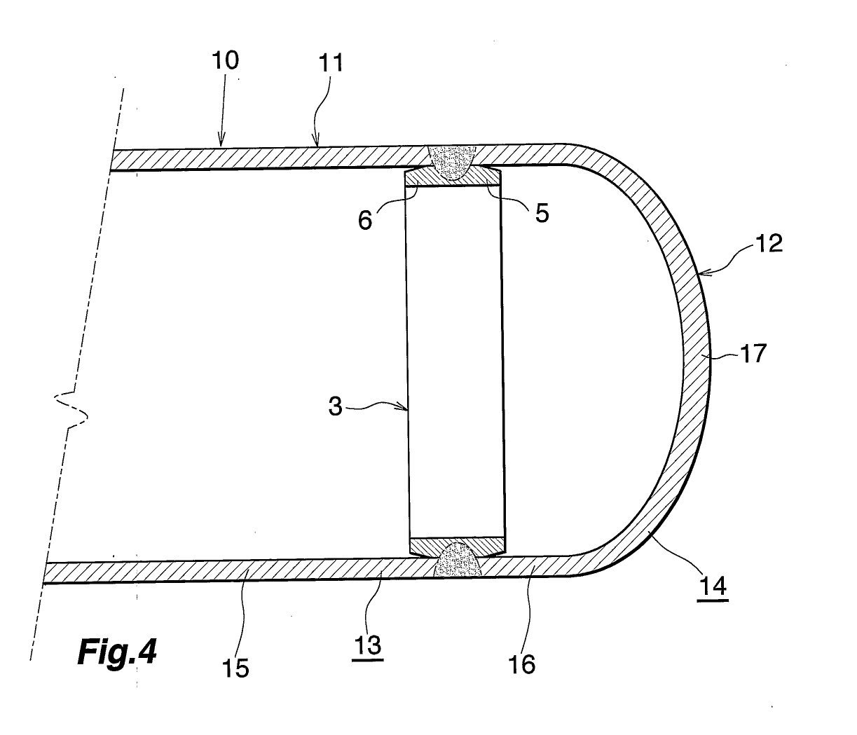

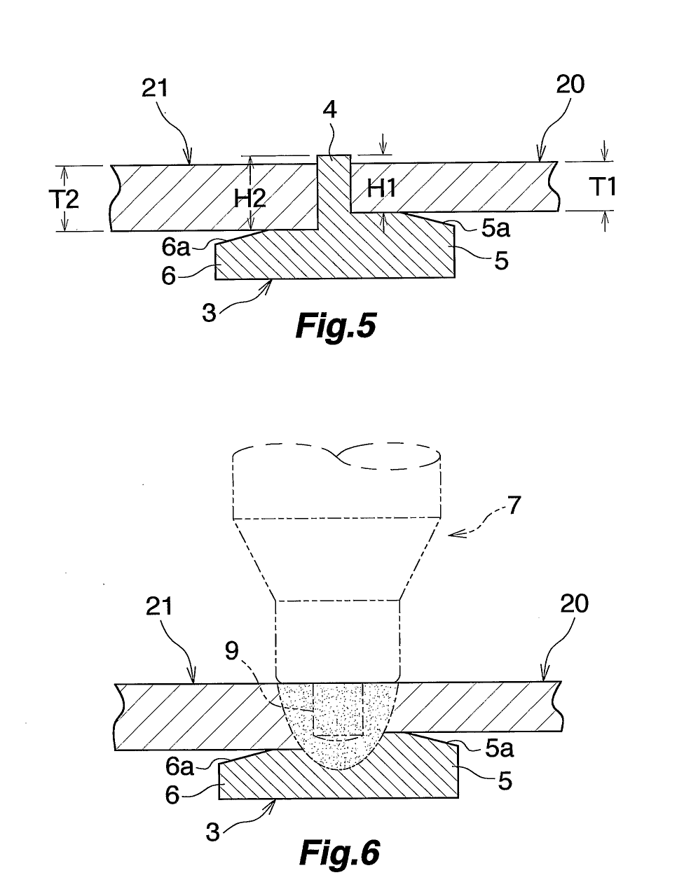

The present embodiment is shown in FIGS. 5 and 6.

In the present embodiment, butt end portions of two cylindrical workpieces (20) and (21) to be joined are of the same outer circumferential length, and the outer circumferential surfaces of the butt end portions of the cylindrical workpieces (20) and (21) are positioned at the same cylindrical surface. However, the present embodiment differs from Embodiment 1 in the following: the butt end portions of the workpieces (20) and (21) differ from each other in wall thickness and inner circumferential length; the support member (3) has a first support portion (5) on one side of the annular, radially outward projection (4) so as to support, from the inside, the first workpiece (20) having a thin-walled butt end portion; the support member (3) has a second support portion (6) on the other side of the annular, radially outward projection (4) so as to support, from the inside, the second workpiece (21) having a thick-walled butt end portion; and the outer circumferential length of the first support portion (5) is longer than the outer circumferential length of the second support portion (6).

Preferably, as in the case of Embodiment 1, when H₁ mm represents the height of the annular, radially outward projection (4) of the support member (3) as measured from the outer circumferential surface of the first support portion (5), T₁ mm represents the wall thickness of the thin-walled butt end portion of the first workpiece (20), H₂ mm represents the height of the annular, radially outward projection (4) as measured from the outer circumferential surface of the second support portion (6), and T₂ mm represents the wall thickness of the thick-walled butt end portion of the second workpiece (21), the conditions T₁≦H₁≦1.2 T₁ and T₂≦H₂≦1. 2 T₂ are satisfied (see FIG. 5). Preferably, as in the case of Embodiment 1, when Lb₁ mm represents the outer circumferential length of the first support portion (5) of the support member (3), Lp₁ mm represents the inner circumferential length of the thin-walled butt end portion of the first workpiece (20), Lb₂ mm represents the outer circumferential length of the second support portion (6) of the support member (3), and Lp₂ mm represents the inner circumferential length of the thick-walled butt end portion of the second workpiece (21), the conditions Lp₁≦Lb₁≦1.01 Lp₁ and Lp₂≦Lb₂≦1.01 Lp₂ are satisfied.

As in the case of the method of Embodiment 1, while the opposite support portions (5) and (6) of the support member (3) are fitted into the workpieces (20) and (21), respectively, and the end faces of the workpieces (20) and (21) abut the corresponding opposite side faces of the annular, radially outward projection (4), the workpieces (20) and (21) and the support member (3) are friction-stir-welded. The relationship between the diameter D of the probe (9) of the friction stir welding tool (7) and the width W of the annular, radially outward projection (4) in the axial direction of the support member (3) is similar to that of Embodiment 1.

In Embodiments 1 and 2, the two workpieces to be joined are cylindrical, tubular members each opened at opposite ends. However, the present invention is not limited thereto. The present invention is applicable to joining of open end portions of two cylindrical workpieces each having an open end and a closed end and joining of an open end portion of a cylindrical workpiece having opened opposite ends and an open end portion of a workpiece having an open end and a closed end. Further, the shape of workpieces to be joined is not limited to a cylindrical shape. The cross-sectional shape of workpieces may be varied as appropriate; for example, the cross-sectional shape may be elliptical.

### INDUSTRIAL APPLICABILITY

The method for friction-stir-welding hollow workpieces according to the present invention is favorably used so as to manufacture metal products, such as aluminum products, for use in various industries.

1. A method for friction-stir-welding hollow workpieces wherein, while open end portions of two hollow workpieces to be joined are butted with each other in such a manner that their outer perimeter surfaces are positioned at the same surface, and an annular support member is disposed so as to support the butt end portions from the inside, the workpieces are joined together by friction stir welding that is performed from the outside,
the method being characterized in that an annular, radially outward projection is formed on the entire outer perimeter surface of the support member in an intermediate region in the axial direction of the support member, and support portions to be fitted into the corresponding butt end portions of the workpieces for supporting the workpieces from the inside are formed on the support member at corresponding opposite sides of the annular, radially outward projection and that, while the support portions of the support member are fitted into the corresponding workpieces, and end faces of the workpieces abut the annular, radially outward projection, the butt end portions of the workpieces and the support member are subjected to friction stir welding that is performed from the outside.

2. A method for friction-stir-welding hollow workpieces according to claim 1, wherein, when W mm represents a width of the annular, radially outward projection in the axial direction of the support member, and D mm represents a probe diameter of a friction stir welding tool, a condition D−W≧1.5 mm is satisfied.

3. A method for friction-stir-welding hollow workpieces according to claim 1, wherein the butt end portions of the two workpieces to be joined are of the same wall thickness and the same inner perimeter length, and the opposite support portions of the support member are of the same outer perimeter length.

4. A method for friction-stir-welding hollow workpieces according to claim 3, wherein, when H mm represents a height of the annular, radially outward projection as measured from the outer perimeter surface of the support member, and T mm represents the wall thickness of the butt end portions of the two workpieces to be joined, a condition T≦H≦1.2 T is satisfied.

5. A method for friction-stir-welding hollow workpieces according to claim 3, wherein, when Lb mm represents an outer perimeter length of the opposite support portions of the support member, and Lp mm represents an inner perimeter length of the butt end portions of the two workpieces to be joined, a condition Lp≦Lb≦1.01 Lp is satisfied.

6. A method for friction-stir-welding hollow workpieces according to claim 1, wherein the butt end portions of the two workpieces to be joined differ from each other in wall thickness and inner perimeter length; the support member has a first support portion on one side of the annular, radially outward projection so as to support, from the inside, a first workpiece of the two workpieces, the first workpiece having a thin-walled butt end portion; the support member has a second support portion on the other side of the annular, radially outward projection so as to support, from the inside, a second workpiece of the two workpieces, the second workpiece having a thick-walled butt end portion; and an outer perimeter length of the first support portion is longer than an outer perimeter length of the second support portion.

7. A method for friction-stir-welding hollow workpieces according to claim 6, wherein, when H₁ mm represents a height of the annular, radially outward projection of the support member as measured from the outer perimeter surface of the first support portion, T₁ mm represents a wall thickness of the thin-walled butt end portion of the first workpiece to be joined, H₂ mm represents a height of the annular, radially outward projection as measured from the outer perimeter surface of the second support portion, and T₂ mm represents a wall thickness of the thick-walled butt end portion of the second workpiece to be joined, conditions T₁≦H₁≦1.2 T₁ and T₂≦H₂≦1.2 T₂ are satisfied.

8. A method for friction-stir-welding hollow workpieces according to claim 6, wherein, when Lb₁ mm represents an outer perimeter length of the first support portion of the support member, Lp₁ mm represents an inner perimeter length of the thin-walled butt end portion of the first workpiece to be joined, Lb₂ mm represents an outer perimeter length of the second support portion of the support member, and Lp₂ mm represents an inner perimeter length of the thick-walled butt end portion of the second workpiece to be joined, conditions Lp₁≦Lb₁≦1.01 Lp₁ and Lp₂≦Lb₂≦1.01 Lp₂ are satisfied.

9. A method for friction-stir-welding hollow workpieces according to claim 1, wherein end portions of the opposite support portions of the support member are formed into tapered portions such that a perimeter length gradually reduces toward respective distal ends.

10. A method for friction-stir-welding hollow workpieces according to claim 1, wherein the two workpieces to be joined and the support member are formed of aluminum.

11. A method for friction-stir-welding hollow workpieces according to claim 10, wherein the two workpieces to be joined and the support member are formed of a JIS A6000 family alloy.

12. A tubular member formed by joining a plurality of tubular workpieces each opened at opposite ends, wherein adjacent tubular workpieces are friction-stir-welded by a method according to claim 1.

13. A vessel comprising a trunk and a closing wall for closing at least one end of the trunk, the trunk being formed by joining a plurality of longitudinal vessel component members such that the adjacent vessel component members are friction-stir-welded by a method according to claim 1.
